(19) United States
(12) Patent Application Publication
(10) Pub. No.: US 2012/0131662 A1
(43) Pub. Date: May 24, 2012

(54) Virtual local area networks in a virtual machine environment

(75) Inventors: Timothy Kuik, Lino Lakes, MN (US); David Thompson, Rogers, MN (US); Saravanakumar Rajendran, San Jose, CA (US)

(73) Assignee: CISCO TECHNOLOGY, INC., San Jose, CA (US)

(21) Appl. No.: 12/927,785

(22) Filed: Nov. 23, 2010

(51) Int. Cl. G06F 21/00; G06F 9/455

(52) U.S. Cl. 726/11; 718/1

(57) ABSTRACT

In one embodiment, a method includes identifying virtual machines operating at a network device and virtual local area networks associated with the virtual machines, creating an allowed list of virtual local area networks at the network device based on the virtual machines operating at the network device, and updating the allowed list in response to changes in the virtual machines at the network device. The network device is configured to forward traffic received from the virtual local area networks on the allowed list to a virtual switch at the network device, and drop traffic received from a virtual local area network not on the allowed list. An apparatus and logic are also disclosed.

### TECHNICAL FIELD

The present disclosure relates generally to virtual local area networks (VLANs) in a virtual machine environment.

### BACKGROUND

Virtualization is a technology which allows one computer to do the job of multiple computers by sharing resources of a single computer across multiple systems. Through the use of virtualization, multiple operating systems and applications can run on the same computer at the same time, thereby increasing utilization and flexibility of hardware. For example, virtualization allows servers to be decoupled from underlying hardware, thus resulting in multiple virtual machines sharing the same physical server hardware. Connectivity between the virtual machines and external network is provided by a virtual switch. The virtual machines may be connected to the virtual switch via an access port and each virtual machine can be part of a different virtual local area network.

### BRIEF DESCRIPTION OF THE FIGURES

FIG. 1 illustrates an example of a network in which embodiments described herein may be implemented.

FIG. 2 depicts an example of a network device useful in implementing embodiments described herein.

FIG. 3 is an example of a table listing virtual local area networks associated with virtual machines in the network of FIG. 1, along with an allowed list of virtual local area networks for each server.

FIG. 4 is a flowchart illustrating an overview of a process for creating and using the allowed list of virtual local area networks.

Corresponding reference characters indicate corresponding parts throughout the several views of the drawings.

### DESCRIPTION OF EXAMPLE EMBODIMENTS

### Overview

In one embodiment, a method generally comprises identifying virtual machines operating at a network device and virtual local area networks associated with the virtual machines, creating an allowed list of virtual local area networks at the network device based on the virtual machines operating at the network device, and updating the allowed list in response to changes in the virtual machines at the network device. The network device is configured to forward traffic received from the virtual local area networks on the allowed list to a virtual switch at the network device, and drop traffic received from a virtual local area network not on the allowed list.

In another embodiment, an apparatus generally comprises a processor for creating an allowed list of virtual local area networks based on virtual machines operating at the apparatus and virtual local area networks associated with the virtual machines, and updating the allowed list in response to changes in the virtual machines. The apparatus further includes a network interface for forwarding traffic received from the virtual local area networks on the allowed list to a virtual switch at the apparatus, and dropping traffic received from a virtual local area network not on the allowed list, and memory for storing the allowed list of virtual local area networks.

### Example Embodiments

The following description is presented to enable one of ordinary skill in the art to make and use the embodiments. Descriptions of specific embodiments and applications are provided only as examples and various modifications will be readily apparent to those skilled in the art. The general principles described herein may be applied to other embodiments and applications. Thus, the embodiments are not to be limited to those shown, but are to be accorded the widest scope consistent with the principles and features described herein. For purpose of clarity, features relating to technical material that is known in the technical fields related to the embodiments have not been described in detail.

Virtualization allows one computer to do the job of multiple computers by sharing the resources of a single computer across multiple systems. Software is used to virtualize hardware resources of a computer, including, for example, CPU (central processing unit), RAM (random access memory), hard disk, and network controller, to create a virtual machine that can run its own operating system and applications. Multiple virtual machines share hardware resources without interfering with each other so that several operating systems and applications can be run at the same time on a single computer. Virtual machines may be used, for example, in a virtual infrastructure to dynamically map physical resources to business needs.

In a virtual environment, virtual switches provide networking connectivity between virtual machines and physical interfaces on a server. Each virtual machine may be part of a different virtual local area network (VLAN). The virtual local area networks allow multiple logical local area networks (LANs) to exist within a single physical LAN. The dynamic nature of virtual machines can effectively change the VLANs that are active at a server at any time. The embodiments described herein dynamically alter an allowed list of VLANs at a network device (e.g., server) based upon the active list of VLANs used by the virtual machines and hypervisor access ports at the server. The allowed list of VLANs on a trunk connecting the server to an upstream switch is thus dynamically changed to keep up with changes to the virtual machines. This allows for unwanted traffic to be dropped by a physical adapter (e.g., network interface card (MC)) at the server, rather than having to be processed within the virtual switch. The embodiments also provide the benefit of only having to maintain data structures for VLANs that are actually in use at each server.

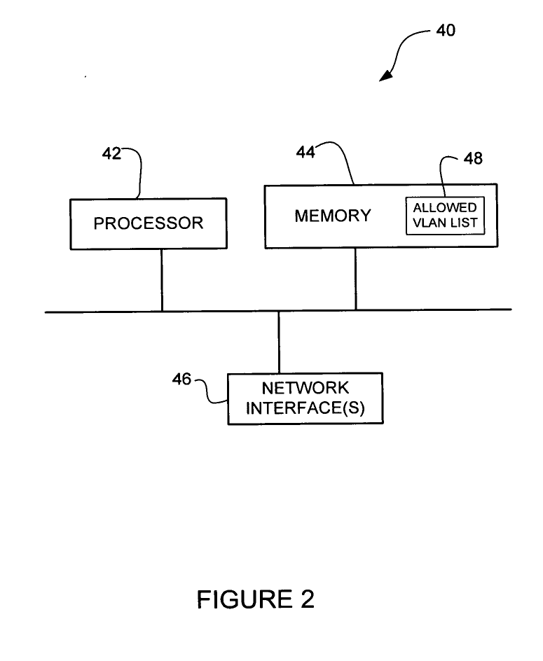

The embodiments described herein operate in the context of a data communications network including multiple network elements. Some of the elements in the network may be network devices such as servers, switches, routers, appliances, and the like. The network device may be implemented on a general purpose network machine such as described below with respect to FIG. 2.

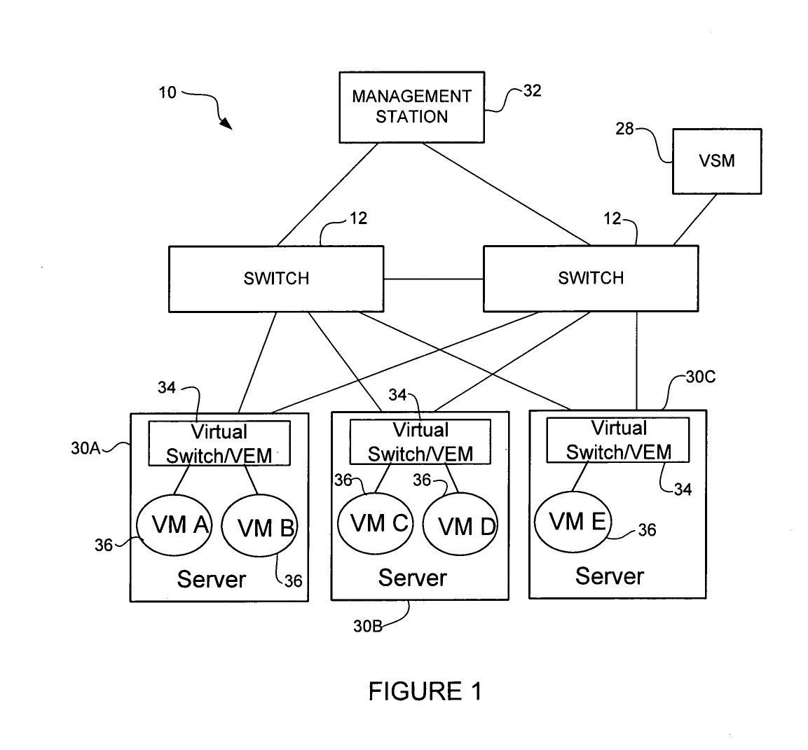

Referring now to the drawings, and first to FIG. 1, an example of a network 10 that may implement embodiments described herein is shown. The network 10 may be configured for use as a data center or any other type of network. The network 10 includes switches 12, which may be hardware implemented network switches or other network devices configured to perform switching or routing functions. In the example shown in FIG. 1, the switches 12 are connected to (i.e., in communication with) three network devices (e.g., servers, hosts) 30A, 30B, 30C. The switches 12 may also be in communication with a management station 32 (e.g., virtualization management platform such as VMware virtual center management station, available from VMware of Palo Alto, Calif.). The management station 32 or one or more management functions may also be integrated into the switches 12 or servers 30A, 30B, 30C.

The switches 12 are programmed to receive and transmit traffic for all VLANs that the servers 30A, 30B, 30C may use. The switches 12 may use VLAN trunk protocol (VTP), in which VLAN lists are maintained in an automated fashion throughout the switched network. As described below, the VLAN list at each server 30A, 30B, 30C is updated based on the virtual machines operating on the server.

Each server 30A, 30B, 30C includes a virtual switch (also referred to herein as a virtual Ethernet module (VEM)) 34, and one or more virtual machines (VM A, VM B, VM C, VM D, VM E) 36. In the example of FIG. 1, VM A and VM B are located at server 30A, VM C and VM D are located at server 30B, and VM E is located at server 30C, each server being physically separate from the other servers. The virtual machines 36 may be moved between servers 30A, 30B, 30C based on traffic patterns, hardware resources, or other criteria. A virtual machine monitor (e.g., hypervisor) may be installed on the server 30A, 30B, 30C and used to dynamically allocate hardware resources to the virtual machines 36.

Each virtual machine 36 is associated with a virtual local area network (e.g., configured with a VLAN ID). The virtual machine 36 is configured to specify the virtual local area network that the virtual machine will use for network communications. As described in detail below, an allowed list of VLANs is created for each server based on the VLANs associated with the virtual machines active on that server.

The servers 30A, 30B, 30C are also in communication with a virtual supervisor module (VSM) 28. The VSM 28 may be located in a network device (e.g., physical appliance) in communication with the servers 30A, 30B, 30C and management station 32 via physical switches 12. The virtual supervisor module 28 may also be a virtual appliance (e.g., virtual machine) installed at one of the servers 30A, 30B, 30C or the VSM may be installed at one of the switches 12.

The virtual supervisor module 28 is configured to provide control/management plane functionality for the virtual machines 36 and control multiple virtual switches 34. The virtual switch 34 provides switching capability at the server 30A, 30B, 30C and operates as a data plane associated with the control plane of the VSM 28. In one embodiment, the virtual supervisor module 28 and virtual Ethernet module 34 operate together to form a distributed virtual switch (e.g., NEXUS 1000V series switch, available from Cisco Systems, Inc. of San Jose, Calif.).

The virtual switch 34 switches traffic between the virtual machines 36 and a physical network interface card (NIC) at each server 30A, 30B, 30C. The server 30A, 30B, 30C includes an Ethernet port for each physical network interface card. The Ethernet ports may be aggregated in a port channel. The virtual switches 34 are in communication with the network via the physical Ethernet interfaces.

The physical interfaces at the servers 30A, 30B, 30C are connected to the switches 12 or other network devices via a trunk that allows multiple VLANs to share the connection between the physical network adapters at the servers and the physical network. The trunk may refer to a network link or aggregated links. The physical network adapter at each server supports multiple VLANs.

As described in detail below, the virtual switch (e.g., virtual Ethernet module 34, virtual supervisor module 28, or a combination of the VEM and VSM) creates an allowed list of VLANs at the server 30A, 30B, 30C, based on the virtual machines 36 active at the server, and programs a physical network adapter (e.g., network interface card) at the server so that only packets from an allowed VLAN are received and processed at the virtual switch 34. All other VLAN traffic is dropped at the network interface card.

It is to be understood that the network shown in FIG. 1 and described above is only an example and that other topologies, network devices, or virtual switches may be used, without departing from the scope of the embodiments. Also, each server may have any number of active virtual machines and each virtual machine may be associated with one or more VLANs.

An example of a network device 40 that may be used to implement embodiments described herein is shown in FIG. 2. In one embodiment, the network device 40 is a programmable machine that may be implemented in hardware, software, or any combination thereof. For example, the network device 40 may create (or update) an allowed virtual local area network list using software (e.g., virtual Ethernet module 34, virtual supervisor module 28). Software may also be used to program (or reprogram) hardware at the network device so that unwanted virtual local area network traffic is dropped by the network interface.

The network device 40 includes one or more processors 42, memory 44, and one or more network interfaces 46. Memory 44 may be a volatile memory or non-volatile storage, which stores various applications, modules, and data for execution and use by the processor 42. An allowed VLAN list 48 may be stored in memory 44.

Logic may be encoded in one or more tangible media for execution by the processor 42. For example, the processor 42 may execute codes stored in a computer-readable medium such as memory 44. The computer-readable medium may be, for example, electronic (e.g., RAM (random access memory), ROM (read-only memory), EPROM (erasable programmable read-only memory)), magnetic, optical (e.g., CD (compact disc), DVD (digital video disc)), electromagnetic, semiconductor technology, or any other suitable medium.

The network interface 46 may comprise one or more interfaces (e.g., cards, adapters, ports) for receiving data, transmitting data to other network devices, and forwarding received data to internal components (e.g., virtual switch 34).

It is to be understood that the network device 40 shown in FIG. 2 and described above is only one example and that different configurations of network devices may be used.

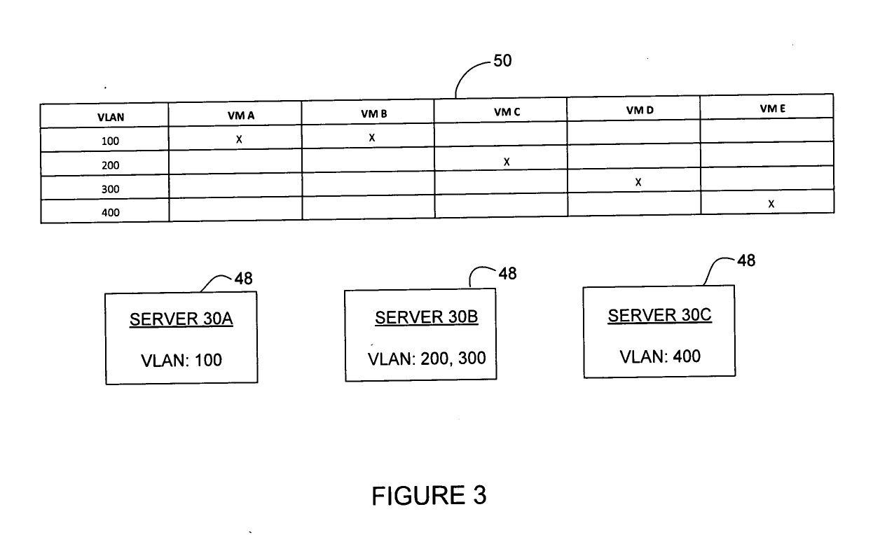

FIG. 3 illustrates an example of a table 50 listing virtual local area networks associated with each virtual machine 36 shown in FIG. 1 and an allowed list of VLANs 48 for each server 30A, 30B, 30C. There may be an allowed list of VLANs initially configured at the server 30A, 30B, 30C by a network or system administrator, for example, or the initial list may be generated by the embodiments described herein. The allowed VLAN list 48 is dynamically altered as changes are made to the virtual machines 36 at the server. In one embodiment, the allowed VLAN list 48 is used to program (or reprogram) hardware (e.g., network interface card or other physical adapter) so that unwanted VLAN traffic is dropped by the network interface card rather than having to be processed by the virtual switch 34. The allowed VLAN list 48 is preferably configured on a per server basis so that the allowed list applies to any network interface between the server and the switch 12 (or other network device).

In the example shown in FIG. 3, VM A is associated with VLAN 100; VM B with VLAN 100; VM C with VLAN 200; VM D with VLAN 300; and VM E with VLAN 400. Based on the table 50, an allowed list of VLANs 48 is created for each server as shown in FIG. 3 (server 30A: VLAN 100; server 30B: VLANs 200, 300; server 30C: VLAN 400).

The allowed list of VLANs 48 at each server is updated based upon the virtual local area networks that are used at the server according to the virtual machines currently operating on the server. If a new virtual local area network is needed due to Vmotion of a virtual machine 36 or other configuration change, the allowed list of VLANs is updated to accept the new virtual local area network. For example, as virtual machines 36 are started or migrated onto a server, VLANs that are associated with the virtual machines and not already on the list, are added to the allowed VLAN list 48. As virtual machines 36 are stopped or migrated off a server, any VLANs that are unique to the virtual machines are removed from the allowed list. In the example shown in FIGS. 1 and 3, if VM B is moved from server 30A to server 30C, the allowed list of VLANs at server 30C would be updated to include VLAN 100. Since VLAN 100 is still used by VM A at server 30A, there would be no change to the allowed

VLAN list at server 30A.

The virtual local area networks may be identified in the list 48 using any identifier (e.g., name, number, label, tag, etc.). Frames may be tagged with VLAN information (e.g., tag header on Ethernet frame) or a field in the frame may identify the VLAN (e.g., internal tag field or encapsulated header). The VLAN information in a packet is used to determine if the packet was received from a virtual local area network in the allowed VLAN list 48.

In one embodiment, port profiles may be used so that the allowed VLAN settings on a trunk can be administered as a policy for the servers. The port profiles define a common set of configuration policies (attributes) for multiple interfaces. The port profiles can be applied to any number of ports and can inherit policies from other port profiles. The port profiles are associated with port configuration policies defined by the network administrator and applied automatically to a large number of ports as they come online in a virtual environment. The port profiles are ‘live’ thus, editing an enabled port profile causes configuration changes to propagate to all interfaces using that port profile. A specification of the allowed VLANs on a trunk may be associated with an ‘inherited’ setting, which is processed so that the allowed list of VLANs is based upon the current list of running virtual machines and hypervisor access ports at the server.

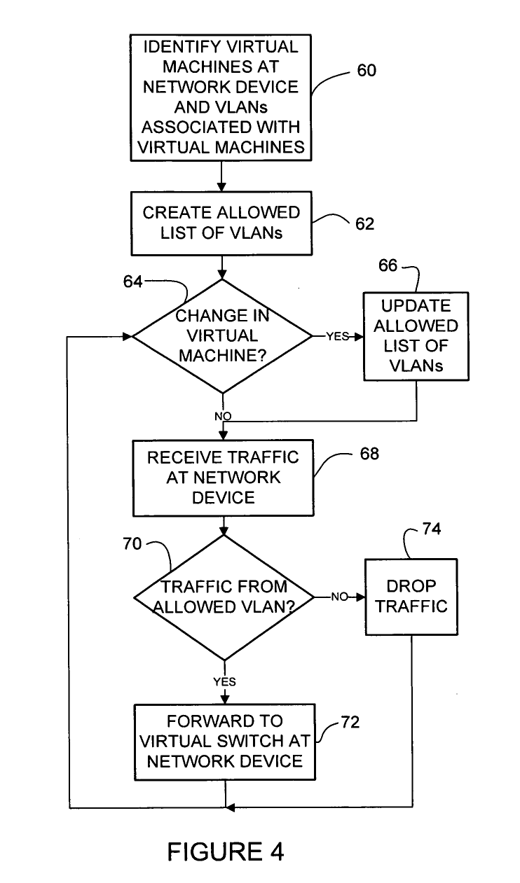

FIG. 4 is a flowchart illustrating an overview of a process for creating and using allowed virtual local area network lists at a network device. At step 60 virtual machines 36 at a network device (e.g., server 30A, 30B, 30C) are identified along with the VLANs associated with the virtual machines. An allowed list of VLANs is created based on the virtual machines operating at the server and the VLANs associated with the virtual machines (step 62). There may be an initial allowed list of VLANs configured at the network device (e.g., network adapter initially configured to accept traffic from all VLANs in the network). In this case the step of creating an allowed list of VLANs comprises updating an existing list. The allowed VLAN list is used to program the network adapter at the network device to drop traffic from virtual local area networks that are not on the allowed VLAN list. If there are any changes in the virtual machines 36 (e.g., started, stopped, moved), which results in a change to the allowed VLAN list, the list is updated (steps 64 and 66).

Steps 68-74 illustrate how traffic is processed at the network adapter (e.g., network interface card) at the network device. Traffic is received at the network device at step 68. If the traffic is from an allowed VLAN, it is forwarded to the virtual switch 34 at the network device (steps 70 and 72). If the traffic is from a VLAN that is not included in the allowed list, the traffic is dropped at the network device, before reaching the virtual switch 34 (steps 70 and 74).

It is to be understood that the process shown in FIG. 4 and described above is only an example and that steps may be removed, added, or reordered, without departing from the scope of the embodiments.

Although the method and apparatus have been described in accordance with the embodiments shown, one of ordinary skill in the art will readily recognize that there could be variations made to the embodiments without departing from the scope of the embodiments. Accordingly, it is intended that all matter contained in the above description and shown in the accompanying drawings shall be interpreted as illustrative and not in a limiting sense.

What is claimed is:

1. A method comprising:
identifying virtual machines operating at a network device and virtual local area networks associated with the virtual machines;
creating an allowed list of virtual local area networks at the network device based on the virtual machines operating at the network device; and
updating said allowed list in response to changes in the virtual machines at the network device;
wherein the network device is configured to forward traffic received from the virtual local area networks on said allowed list to a virtual switch at the network device, and drop traffic received from a virtual local area network not on said allowed list.

2. The method of claim 1 further comprising programming a network interface card at the network device to drop said traffic received from a virtual local area network not on said allowed list.

3. The method of claim 1 wherein updating said allowed list comprises removing the virtual local area network associated with one of the virtual machines at the network device upon migration of the virtual machine to another network device.

4. The method of claim 1 wherein updating said allowed list comprises adding a new virtual local area network associated with a new virtual machine at the network device.

5. The method of claim 1 wherein changes in the virtual machines comprise starting or stopping operation of one of the virtual machines.

6. The method of claim 1 wherein changes in the virtual machines comprise receiving a new virtual machine or removing one of the virtual machines at the network device.

7. The method of claim 1 wherein creating said allowed list of virtual local area networks comprises updating an allowed list of virtual local area networks at the network device.

8. An apparatus comprising:
a processor for:
creating an allowed list of virtual local area networks based on virtual machines operating at the apparatus and virtual local area networks associated with the virtual machines; and
updating said allowed list in response to changes in the virtual machines;
a network interface for forwarding traffic received from the virtual local area networks on said allowed list to a virtual switch at the apparatus, and dropping traffic received from a virtual local area network not on said allowed list; and
memory for storing said allowed list of virtual local area networks.

9. The apparatus of claim 8 wherein the processor is further configured for programming the network interface to drop said traffic received from a virtual local area network not on said allowed list.

10. The apparatus of claim 8 wherein updating said allowed list comprises removing the virtual local area network associated with one of the virtual machines at the apparatus upon migration of the virtual machine to a network device.

11. The apparatus of claim 8 wherein updating said allowed list comprises adding a new virtual local area network associated with a new virtual machine at the apparatus.

12. The apparatus of claim 8 wherein changes in the virtual machine comprise starting or stopping operation of one of the virtual machines.

13. The apparatus of claim 8 wherein changes in the virtual machines comprise receiving a new virtual machine or removing one of the virtual machines at the apparatus.

14. The apparatus of claim 8 wherein creating said allowed list of virtual local area networks comprises updating an allowed list of virtual local area networks at the apparatus.

15. Logic encoded in one or more tangible media for execution and when executed operable to:
identify virtual machines operating at a network device and virtual local area networks associated with the virtual machines;
create an allowed list of virtual local area networks at the network device based on the virtual machines operating at the network device;
update said allowed list in response to changes in the virtual machines at the network device; and
program a network interface to forward traffic received from the virtual local area networks on said allowed list to a virtual switch at the network device, and drop traffic received from a virtual local area network not on said allowed list.

16. The logic of claim 15 wherein creating an allowed list of virtual local area networks comprises updating an allowed list of virtual local area networks.

17. The logic of claim 15 wherein updating said allowed list comprises removing the virtual local area network associated with one of the virtual machines at the network device upon migration of the virtual machine to another network device.

18. The logic of claim 15 wherein updating said allowed list comprises adding a new virtual local area network associated with a new virtual machine at the network device.

19. The logic of claim 15 wherein changes in the virtual machines comprise starting or stopping operation of one of the virtual machines.

20. The logic of claim 15 wherein changes in the virtual machines comprise receiving a new virtual machine or removing one of the virtual machines at the network device.
